(19) United States
(12) Patent Application Publication
(10) Pub. No.: US 2015/0250365 A1
(43) Pub. Date: Sep. 10, 2015

(54) DEVICE COMPRISING ACTUATING MECHANISMS DRIVEN BY HYDRAULIC FORCE FOR LOWERING THE LID AND THE SEAT OF A TOILET, INDEPENDENTLY AND SIMULTANEOUSLY

(71) Applicant: Carlo GOMEZ ESPAÑA COLLIGNON, (US)

(72) Inventor: Carlo Gomez Espana Collignon, Zapopan (MX)

(21) Appl. No.: 14/426,526

(22) PCT Filed: Oct. 10, 2012
(86) PCT No.: PCT/MX2012/000098

§ 371 Date: Mar. 6, 2015

(30) Foreign Application Priority Data
Sep. 6, 2012 (MX) MX/A/2012/010330

(51) Int. Cl. A47K 13/10; F16H 35/18

(52) U.S. Cl. CPC A47K 13/10; F16H 35/18

(57) ABSTRACT

A device including mechanisms for lowering the lid and the seat of a toilet, having a hydraulic piston for actuating the mechanisms by water pressure.

### FIELD OF THE INVENTION

This invention is about the means and devices used in toilets; in particular, it refers to the means used to lower the lid and the toilet seat, in a simultaneous or independent manner and specifically, it refers to a novel device with actuating devices driven by hydraulic force in order to lower the lid and the toilet seat in an independent or simultaneous form, without using the hands; they are triggered once the toilet has been used and the water has been discharged from the discharge tank.

### BACKGROUND OF THE INVENTION

In the state of the technique of the same inventor (Carlo Gomez Espana Collignon) has developed several devices in order to lift and lower the cover and the toilet seat and he has filed several applications, such as the patent application number: MX/a/2011/002472 named as device with actuating devices with pedal and hydraulic mechanism in order to lift and lower the lid and the toilet seat; this is characterized by having an adapted structure to be fixed in the back of the mouth of a toilet and adapted to house with rotability, the first axis and a second axis placed in a collinear manner and partially separated in its attached ends within the structure; said first axis is joined at the end and it projects laterally from said support-housing structure on the rear side of a toilet cover; said second axis stands out on its end on the opposite side of said structure to be fixed on the rear side of a toilet seat; the first axis and the second axis have—on the attached collinear ends—a first cam and a second cam, respectively, which have been adapted to receive and hold the end of a first wire and a second wire, which come out below the support structure and extends from the rear of the toilet on the side until the front thereof; the end of a first wire connects to a first pedal element and the end of a second wire is connected to a second pedal element, they are independent one from the other, but they are mounted on the same structure to be operated by foot; the device may comprise an hydraulic piston drive mechanism to lower the cover and seat automatically when the toilet water tank is discharged.

There is also the patent application number MX/a/2011/001905 named as device with drive mechanisms to lift and lower the cover and the toilet seat in an independent form or simultaneous that has a structure adapted to be set on the rear part of the mouth of a toilet, adapted to house rotability on a first axis and second axis placed in a collinear manner and partially separated on its attachment ends within the structure; said first axis is attached to the laterally projecting end of said support structure-shell on the rear side of the toilet seat; said second axis protrudes at its end on the opposite side of said structure for attachment to the rear side of the toilet seat; said first and second axis have attachments on the collinear ends, a first mechanism comprising a first and second gear fixed in a recess of the corresponding ends of the first and second axis; adapted to engage with a third drive gear placed below them on a fixed axis, which is engaged and driven by a toothed element upstroke of a first hydraulic piston powered by pressurized water; comprising a second mechanism with a hydraulic piston powered by water pressure to rotate in the opposite direction of said shafts to automatically lower the lid and seat when the toilet tank is discharged.

There is also the patent granted MX286572B filed on May 18, 2009 and granted on Apr. 19, 2011, which protects an hydraulic actuator for raising and lowering the cover and toilet seat, characterized by comprising two attached hollow chambers a left and a right one, this includes a left and right rotary shaft, respectively; both axis comprising a counterweight fixedly rotatable with the shaft within the chambers; each chamber also houses a left and right elastic diaphragm, attached and interacting with the counterweights; said diaphragms comprise at least one pin connection wherein a supply duct and/or working fluid outlet is connected to push-actuate the counterweights when inflated with working fluid supplied by an automatic system or by a system of contact drive elements and cause the rotation of said shafts connected to a cover and a toilet seat, respectively, which comprise—on the back—a right and left eyebrow connection with an orifice through which a left and right fixing bolt is inserted which is fixed at the ends of the rotating shafts with the corresponding counterweights.

It also holds patent number MX 285247 B applied on Sep. 4, 2009 and it was issued on Mar. 7, 2011, the above protects improvements to the hydraulic actuator device to raise and lower the cover and toilet seat, characterized by a left and right module which consists of a shell with a central transverse axis whose ends protrude; said housing is divided into three cavities; the end of the left axis is attached to the cover and the end of the right axis to the seat, the opposite end is fixed to a drive plate of three fins, a fin is housed in each cavity of the housing, it also houses the cylindrical diaphragm and when filled with water, they pressure the fins simultaneously causing a partial rotation of the shaft that when coupled to the lid and seat, it lifts them in a joint or separate manner or throws them in its rotational displacement when discharged; said diaphragms are feed through a check valve that enables allowing the passage of water supply to fill the diaphragms and to discharge the diaphragms through a duct towards the toilet tank when the button of the toilet is pressed; the left and right drive valves—by foot—are connected to a general water distributor and connected to the water supply duct.

In the several applications afore-stated there is a broad review of the problems in toilets that use conventional covers and seats, and other devices that may solve the problem in a completely different manner, they form part of the state of the art and define the background and for the purposes of this application they are made extensive to define and understand the state of the art.

Notwithstanding the above, and in order to improve and to make available the device with actuating mechanisms driven by hydraulic force to lower the cover and toilet seat in an independent or simultaneous manner, that is more efficient and practical on an operational basis, more functional, durable and with an optimal structure and a better drive is the reason why the device of the present invention was developed.

The device of this invention, as this has been conceptualized is novel and is inventive enough because it has been designed and developed after several tests, developments, research, financial resource investment, investment of personnel and supplies which together has allowed obtaining a device that may not be deduced by a technician with average knowledge in the field under the information of the state of the art.

### PURPOSES OF THE INVENTION

The main purpose of this invention is to make a device available with drive mechanisms driven by water power to lower the cover and toilet seat in an independent or simultaneous manner that is triggered automatically by pulling the lever or pressing the flushing button from the water tank of the toilet and avoiding the use of the hands to lower them and preventing that they remain lifted and thus avoiding an unpleasant sight.

Another purpose of the invention is to make the device available with drive mechanisms driven by hydraulic force to lower the cover and toilet seat in an independent or simultaneous manner that enables a greater safety and hygiene to the toilet users.

Another purpose of the invention is to make the device available with drive mechanisms driven by hydraulic force to lower the cover and toilet seat in an independent and simultaneous manner that prevents users from contracting infections.

Another purpose of the invention is to make said device available with the drive mechanisms driven by hydraulic force to lower the cover and toilet seat in an independent or simultaneous manner that also has a simple structure and it is easy to manufacture and assembly and easily driven and with an easy installation.

Another purpose of the invention is to make the device available with drive mechanisms driven by waterpower to lower the cover and toilet seat in an independent or simultaneous manner that is also resistant and durable.

Moreover, all those qualities and purposes that will be apparent when describing this invention supported in the modalities described.

### BRIEF DESCRIPTION OF THE INVENTION

In a general manner, the device with drive mechanisms driven by hydraulic force to lower the cover and toilet seat, in an independent or simultaneous manner, pursuant to this invention consists in a support-shell structure that has a base and a cover, they are fixed to each other with fixing means; the base of the housing adapted with holes in the ends to receive the fixing means for fixing the device over the toilet body and on the back of the mouth of the toilet; one of said fixing means is adapted to fix under the toilet and in the back a hydraulic piston retractable two-ways for driving the internal mechanisms of the device housed in said housing to lower the cover and seat once the toilet has been used and has driven the flushing tank discharge.

Said hydraulic piston two ways retractable for driving the internal mechanisms of the device works based on the balance and unbalance of pressure inside and has a body base comprising an upper end and a lower end threaded and an intermediate perpendicular derivation with a threaded end; the lower threaded end is adapted to receive a duct-shaped threaded water supply from the source of water supply to the toilet, the intermediate perpendicular derivation receives a second water feeding duct-in a threaded from to the box or toilet tank; meanwhile, the upper threaded end receives an intermediate hollow cylindrical body with an internal rope and perimeter seal element, who in turn receives in its upper end a upper threaded cover with perimeter seal element adapted to receive the fixing means from the device to the toilet; internally, said piston houses a lower base of the stem with sealing means who will receive underside the force exerted by the water from the water supply and where the arrow of the piston rod is coupled and is wrapped by a spring element that rests on said lower base; said top cover has a central hollow threaded adapted to receive in a threaded form the fixing means of the device which is hollow and wherein said piston is also subject to the toilet and to the device; the means of adjustment and pressure are threaded in said fixing means of the device between the upper cover of the piston and the lower zone and back of the body of the toilet to exert pressure on it and hold the device firmly.

The arrow of the piston rod has a cavity in its upper end and is adapted to receive and connect the lower end of a main cam for the rotary drive mechanisms that are housed inside the housing to rotate the lid and the toilet seat and to lower them.

Said main drive cam is housed in a compartment of the base of the housing and comprises a vertical stem with two upper arms in “T” shape that slide along two side slots on the base and a perpendicular arm adapted to receive a spring element which is compressed by a fixed cover with fixing means in a zone over said compartment where said main cam is housed and is connected to the piston rod arrow and that facilitates the reverse and fall of said elements in collaboration with the spring element that wraps the piston rod arrow; said main cam also comprises a second arm projected later that defines a drive of a first and second connection cam “A” and “B” housed in fixed turning axis in the cover and the toilet seat to make them turn.

When there is less pressure in water storing tank of the toilet due to the toilet drain action, in other words, when the lever is actuated to drain the toilet tank to flush down waste, it creates different pressure inside the piston allowing the water that comes from the water supply duct from the water supply connected in the lower end of the hydraulic piston to offer greater pressure causing the water to move up the lower base of the stem, which has the arrow piston rod inserted and therefore, it is also moved up and because the arrow of the piston rod is connected to the main cam, it also moves up; the water continues its path through the intermediate perpendicular derivation where the water supply pipeline connects to the box or the rear toilet tank.

Said lower base of the stem comprises said perimeter seal element that preferably consists of an “O”ring V—of neoprene—that helps to keep the pressure on the underside of the lower base of the stem.

When the water tank of the toilet fills up and closes its water gate, the difference in pressure is zero in the piston; and the spring element of the arrow piston rod facilitates the return and the repositioning of said piston rod to its initial position; this also happens in the main cam as it returns to its initial position due to the spring element.

Furthermore, in order to shift the lower base of the piston rod to its initial position and so that this is faster, said base has a small hole that allows passage of a volume of water, which allows it to move more easily to the start position.

Therefore, the previous description is summarized in the fact that the lower base of the stem and the piston rod arrow connected to said base has a vertical displacement, upwards when the pressure differential is not zero, and downwards, when there is a balance in pressure and the pressure difference is zero.

The housing is adapted to house and receives the drive mechanisms to lower the lid and toilet seat in a simultaneous or separate manner; which consist in a square arrow to drive the seat, adapted to receive and hold in its inner end a first cam connection “A” placed in a position over the main cam and in its outer end connected to a guide element that is housed on a support base and said base is connected to a brake fluid or of any other nature that slows the rotation, which is housed in a support base for the brake that is coupled in an inner cavity of one of the lateral projections with a hollow seat and on the outer side a coupling edge defined that is coupled in a cavity in a similar form than the inner surface of two end projections with a recess in the back of the cover; in the corresponding cavity of the end protrusions on the back of the cover one finds an insert with a central hollowness in order to drive the lid, there is a connection bolt of the seat with the mechanism and is housed in the hollowness of the projected end of the cover passing by the insert, brake and the support base of the guide element of the squared arrow. And on a second instance by a second cam of “B” connection placed in a position over the main cam that comprises the first hollow cylindrical projection adapted to receive with a rotation capacity independent to the end of the square arrow that goes through the first cam of the “A” connection, so that the end of said squared arrow serves as the center of the rotation of the second cam of the “B” connection, without having an interaction between them; Said second connection “B” cam, comprises on the opposite end a central hollowness adapted to receive a cylindrical body with a hollowness that receives the end of a second squared bold that passes through the second fluid brake or of any other nature that slows the rotation, which is housed in a support base for the brake that is coupled in an internal cavity of the other of the lateral projections with a hollow seat; in the corresponding cavity of the end projections of the back of the seat one finds an insert with a central hollowness in order to drive the seat; said bolt enables the connection of the seat with the mechanism and is housed in the cavity of the seat passing by the insert, the brake and the cylindrical body housed in said second connection cam “B”.

In the preferred modality of the invention, said first cam of the “A” connection has a cylindrical form with a central cavity and comprises a cylindrical projection of lesser diameter where it penetrates and connects the end of the squared arrow and externally comprises a semicircular rib as a guide of the circular shift in a housing groove; there is also a stopper element where the push section operates of the second arm subsequently projected from the main cam that is operated by the piston.

In its preferred mode, said second cam “B” connection has a cylindrical form with a central cavity and has a cylindrical projection of lesser diameter adapted to receive the end of the squared arrow only as support in its rotation; externally, it comprises a semicircular rib as circular displacement guide in a groove in the housing; it also comprises a stopping element where the section of the second arm thrust is projected in the main cam operated by the piston.

A selection mechanism of the connection cams “A” or “B” is mounted internally in the housing and defines a selection button that is mounted slidable on the rear slot of the housing and acts upon the main cam, displacing it to act over one of the connection cams “A” or “B” to only lower the seat or simultaneously lowering the cover and the seat or also to keep the main cam in position where it does not upon any of said connection cams “A” or “B”.

To further understand the characteristics of the invention, as part of this description, and as an integral part thereof, there are drawings in order to illustrate and in a non-limiting form they are described below:

### BRIEF DESCRIPTION OF THE DRAWINGS

Drawing 1 shows the view in rear perspective of the device with drive mechanisms driven by hydraulic force to lower the cover and toilet seat, without part of the housing to show internal drive mechanisms.

Drawing 2 shows a conventional view of the device with drive mechanisms to lift and lower the cover and toilet seat, without a seat or cover.

Drawing 3 shows a conventional view of the device with drive mechanisms to lift and lower the cover and toilet seat, with no seat, or cover and without the housing cover.

Drawing 4 shows the hydraulic piston that is attached to the toilet with fixing means of the housing, also showing the main cam of the device with drive mechanisms to lift and lower the cover and toilet seat.

Drawing 5 and 5a show a drive and an assembly, of the internal drive mechanisms of the housing that enable the lowering of the cover and toilet seat.

Drawing 6 shows a conventional view of the assembly of the seat and cover of the toilet with some components of the drive mechanisms of the device, pursuant to this invention.

Drawing 7 shows the drive of a hydraulic brake that is mounted on the drive mechanisms of the device to lower the cover and toilet seat that reduces the rotation speed for a soft fall of the cover and/or seat.

Drawings 8, 8a and 8b show rear views of the device with drive mechanisms driven by hydraulic force to lower the cover and the toilet seat, in an independent or simultaneous manner, with the selection mechanism to select if only the seat is lowered or if the cover and seat are lowered simultaneously or if the mechanism is left in a non-drive position.

For a better understanding of the invention, there is now a detailed description of some of the modalities thereof, this is shown on the drawings only for illustration purposes and in a non-limiting form, they are attached to this description.

### DETAILED DESCRIPTION OF THE INVENTION

The characteristic details of the device with drive mechanisms driven by hydraulic force to lower the cover and the toilet seat, in an independent or simultaneous manner are clearly shown in the following description and on the illustration drawings that are herein attached, they are reference signs in order to mark/show the same parts.

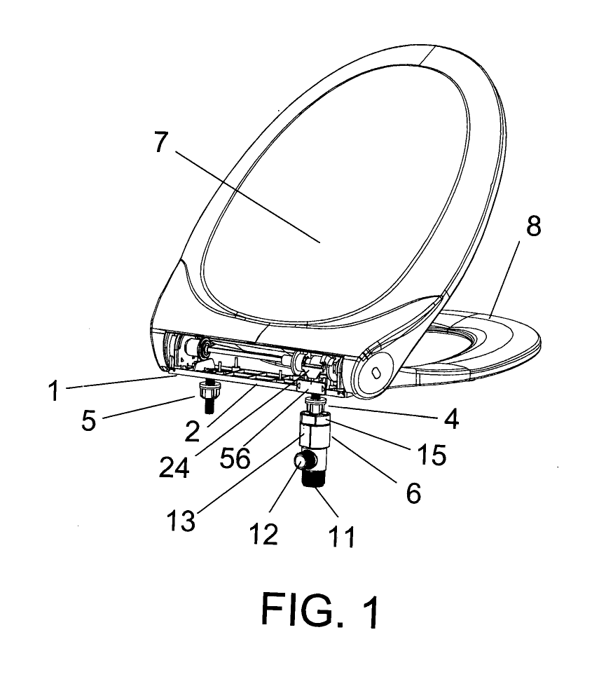

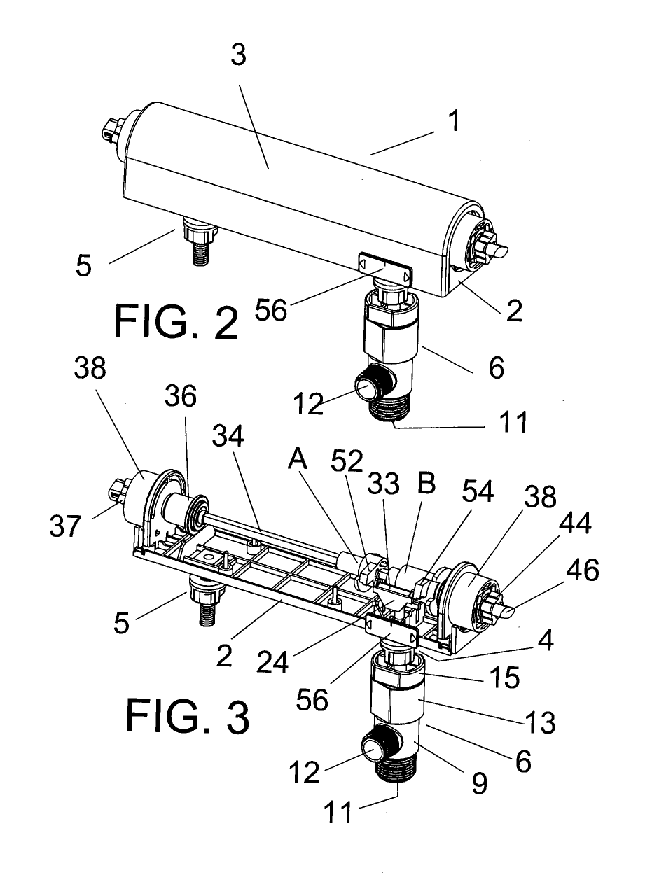

In reference to FIGS. 1 to 4, the device with activating mechanisms propelled by hydraulic force to lower the seat and lid of a toilet, it consists of a support carcass structure 1 that defines a base 2 and a lid 3, fixed between each other with fixating means (not shown); base 2 of the carcass is adapted with two holes on the ends to receive fixation means 4 and 5 allowing setting the device on the body of the toilet and on the back of the mouth thereof; fixation media 4 is adapted to set the device under the toilet and at the same time to adhere on the lower and upper parts of the toilet a hydraulic piston 6 is retractile with two ways to action the internal mechanisms of the device housed in said carcass 1 to lower lid 7 and seat 8 once the toilet has been used and the toilet flush lever has been activated to release discharge water.

Said retractile two way hydraulic piston 6 to activate the device internal mechanisms of the device, works based on the balance and unbalance of pressure inside and it consists of a body base 9 that consists of an upper end 10 and an lower end 11 which are threaded as well as an intermediate perpendicular derivation 12 with the threaded end. The threaded lower end 11 is adapted to receive a threaded water supply duct (not shown) from the toilet water supply source, intermediate perpendicular derivation receives a second threaded water feeding duct (not shown) to the box or deposit behind the toilet 8 not shown); in both the upper threaded end 10 receives a hollow cylinder-shaped body 13 with an internal cord and perimeter seal element 14, which receives on its upper end an upper threaded cap 15 with the perimeter seal element 16, which is adapted to receive fixing means 4 of the device to the toilet; internally said piston 6 holds an inferior base of rod 17 with seal element 18 which will receive, on its lower face, the force exerted by the water from the source of the water and where the rod arrow 19 of the piston is coupled, which is covered by a spring element 20 resting over said inferior base 17; said upper cap 13 has a central threaded cavity 21 adapted to receive, in a threaded form, the means to set 4 of the hollow device and with which said piston 5 is also fixed to the toilet and to the device; means for adjustment and pressure 4a are threaded into said setting means 4 between the upper lid of piston 15 and the lower and back zone of the toilet, to exert pressure against it and hold the device securely in place.

The arrow on stem 19 of the piston has a cavity 22 in its upper end and is adapted to receive and connect lower end 23 of a main cam 24 for the spinning conditioning of the mechanisms inside carcass 1 to make lid 7 spin and seat 8 of the toilet and cause it to descend.

Said principal action cam 24 is hosted in space 25 of base 2 of carcass 1 and consists of a vertical stem with two upper arms forming a “T” 26 that slide through two lateral slots 27 of compartment 25 of base 2 of carcass 1 where it is located, and a perpendicular front arm 28 adapted to receive spring element 29 compressed through a fixed 30 lid with setting means 31 in a zone over said compartment 25 where said principal cam is located connected to the arrow of stem 19 of the piston and facilitates the recoil and descent of said elements together with spring element 20 wrapping the stem arrow 19 of the piston. Aforesaid main cam 24 in addition consists of a second arm 32 projected on the back which defines a pushing section 33 of a first and second levies of “A” and “B” connection coupled on fixed spinning axis on lid 7 and on seat 8 of the toilet to make them spin.

Said lower base 17 of the stem contains said perimeter seal element 18, which consists of a neoprene “O”ring V, which helps it maintain the water exerting pressure on the lower face of said lower base 17 of the stem.

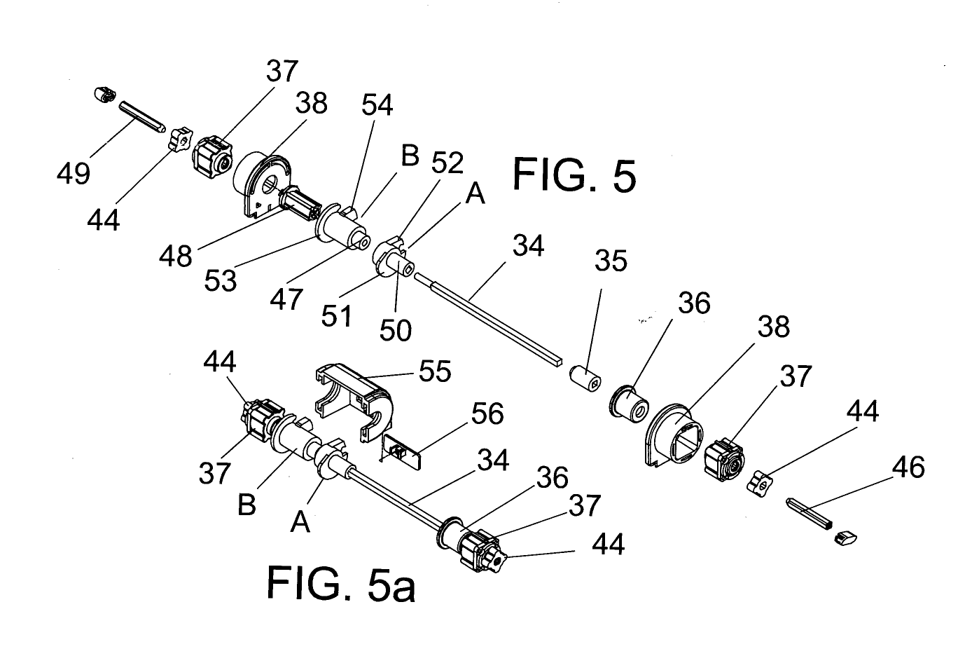

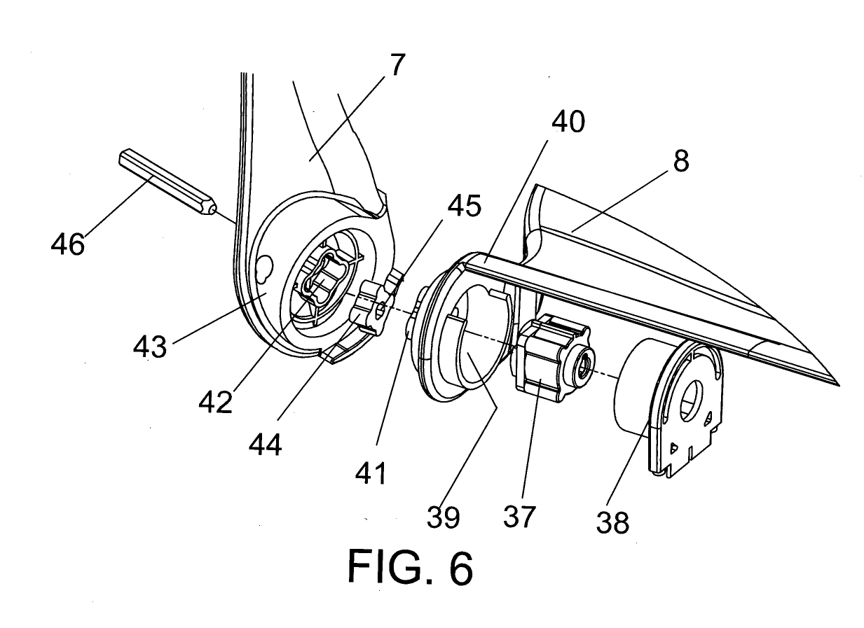

According to FIGS. 1, 3, 4 and preferably placing greater emphasis on FIGS. 5, 5a and 6, carcass 1 is adapted to host and receive action mechanisms to lower lid 7 and seat 8 simultaneously or separately; which consists first on a square arrow 34 to action seat 7, adapted to receive and couple a first “A” connection cam on its inside end, place in a position above the main cam 24 and on the inside connected to a 35 guiding element place on a supporting base 36 and said base is connected to a fluid brake 37 (the brake may be of any type; for the purposes of the preferred mode of the invention it is a fluid brake) that slows spinning. It is placed on a brake support base 38 coupled in an internal cavity 39 of one of the lateral internal cavity 39 of one of the exits 40 of seat 8 and on whose outer face there is a coupling edge that is coupled in a similar shaped cavity 42 to that of the inside face of the two end 43 exits of the brake section of lid 7; on the corresponding 42 cavity of the two exit ends of the back of lid 7, insert 44 is placed with a central 45 cavity; to action lid 7, a connecting bolt for seat 46 with the mechanism is placed in the cavity for end exit 43 of lid 7 going through insert 44 brake 37 and the support base of guide element 36 of square 34 arrow. On second instance, through a second “B” connection cam placed in a position above the main cam 24, which consists of a first hollow cylinder shaped projection 47 adapted to receive, with spinning capability separate from the end of square arrow 34 going through the first “A” connection cam so the end of said square arrow 34 is the center for the spinning of the second “B” connection cam, without interaction between them. Said second “B” connection cam consists of a central cavity on the opposite end adapted to receive a cylinder shaped body 48 with a cavity receiving the end of a second square bolt 49 going through a second fluid brake 37 which slows the spinning, it is located on a brake supporting base 38 coupled in an internal cavity 39 of the other lateral exits 40 with a cavity on seat 7. On the cavity 42 corresponding for end exits 43 of the back of seat 7 insert 44 is located with a central cavity through which the second square bold 49 goes through in order to activate seat 7 with the mechanism and it is located on the cavity of seat 42 across insert 44, brake 37 and cylinder body 48 located on said second “B” connecting cam.

Said first “A” connection cam is shaped like a cylinder with a central cavity and consists of a cylinder 50 projection of smaller diameter where the end of square arrow 34 penetrates and connects and externally consists of a semicircular rib 51 as a circular shifting guide in a slot of the carcass. It also includes a stoppage element 52 where push section 33 of arm 32 projected on the back of main cam 24 acts, which is put in action by piston 6.

Said second “B” connection cam is cylinder-shaped with a central cavity and consists of a cylinder projection of smaller diameter 47 adapted to receive the end of square arrow 34 only as support for its spin; and externally consists of a semi-circular rib 53 to guide the circular displacement in a slot of the carcass; it also contains a stop element 54 where push section 33 of the second arm 32 project on the back of the main cam 24 acts, put in action by piston 6.

Referring to FIGS. 1 to 5a, a selecting mechanism 55 of “A” and “B” connecting cams is mounted internally on carcass 1 and defines a sector 56 button which is sliding mounted in a slot behind carcass 1 and which acts on the main cam, displacing it to act on one of “A” or “B” connecting cams to only lower seat 8 or to simultaneously lower lid 7 and seat 8, or to leave main cam 24 in a position not to act on any of said connecting “A” or “B” connecting cams.

When there is a smaller pressure on the water storage tank of the toilet due to the flushing action of the toilet, that is, when the flush lever of the toilet is activated to discharge waste, a pressure differential is created on the inside of piston 6 allowing the water coming from the water supply duct connected to the lower end of hydraulic piston 6 to offer more pressure, making water displace lower base 17 of the stem upward, which has the stem arrow 19 of the piston inserted and is therefore displaced upward as it is connected to stem arrow 19 of the piston to the principal cam 24, it is also displaced up. The water continues through intermediate perpendicular derivation 12 where it is connected to water feeding duct to the box or deposit behind the toilet. Main cam 24, through its vertical displacement, if it is in a co-linear position to “A” or “B” connecting cams in its vertical displacement, shall act on one of them in order to acting mechanisms to spin to lower only the seat when “A” connecting cam is activated or simultaneously lower the lid and seat when “B” connecting cam is activated.

When the water tank of the toilet is filled and the water way compartment is closed, the pressure differential is zero on piston 6; and spring element 20 of the stem arrow 19 of the piston facilitates the return and repositioning of said stem 19 of the piston to its starting position; the same is generated on principal cam 24 which is returned to its starting position by the effect of spring element 29. In addition, in order to displace lower base 17 of the stem of piston 6 to its starting position and to make this faster; said base 17 has a small hole (not shown) on the bottom which allows the passage of a volume of water allowing easier displacement to the starting position.

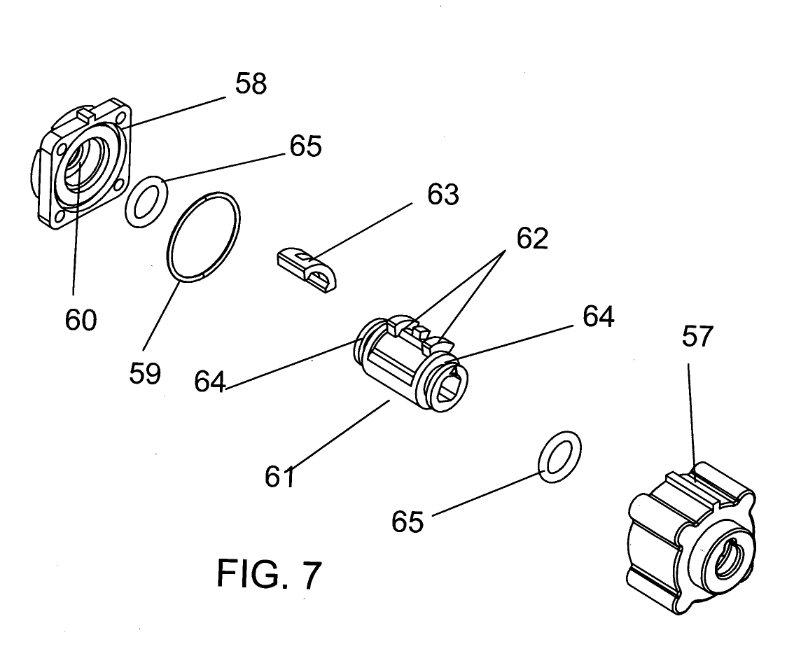

In reference to FIG. 7, hydraulic brake 37 consists of a cylinder shaped carcass 57 with a lid 58, which is firmly fixed against said cylinder carcass with seal 59; said carcass defines a hydraulic chamber with a viscous control fluid. This cylinder shaped carcass consists of a cylinder shaped cavity 60 adapted to receive an arrow or hollow central pivot placed on said hydraulic control camera, which consists of rabbets and exit 62 on its external Wall to receive a moving element 63 to control spinning as elements offering resistance to spinning through the effect of the viscous fluid inside the hydraulic chamber and on the ends it has peripheral rabbets 64 to receive seal 65 O-ring to prevent the leaking of the viscous fluid. Said arrow or hollow central pivot 61 receives a square bolt 46 or 49, fixed to lid 7 or seat 8 (see FIGS. 1, 5 and 6), therefore said device allows the deceleration of the rotation buffering the soft falling of the lid and/or toilet seat.

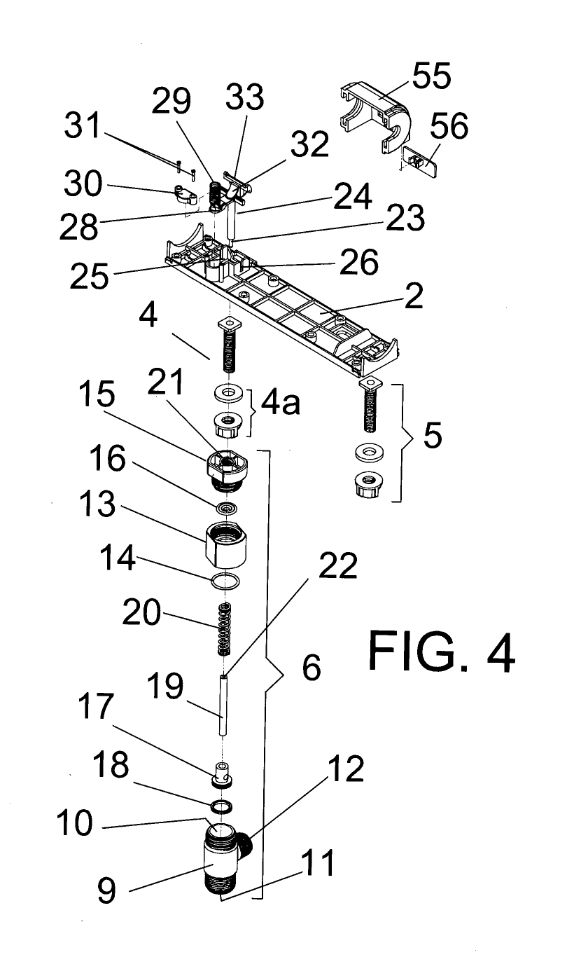

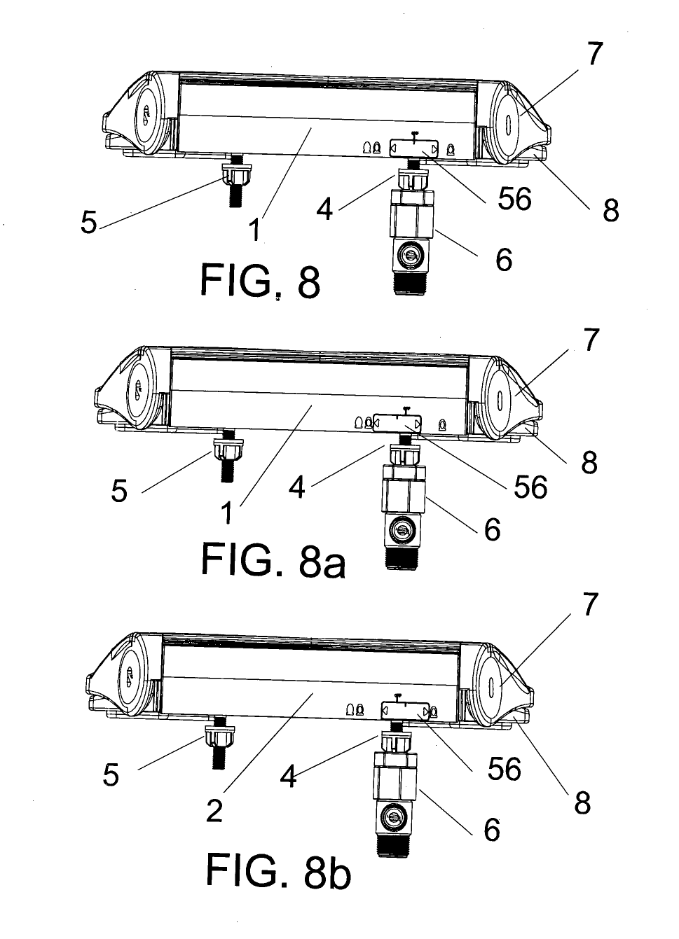

FIG. 8 shows selecting button 56 of selecting mechanism 55 (see FIGS. 4 and 5a) in a central position where push section 33 of the main cam does not activate any of connecting cams “A” or “B”.

FIG. 8a shows selector button 56 of selecting mechanism 55 (see FIGS. 4 and 5a) in left position where the principal cam has been deviated to the left in order for push section 33 to activate “B” connecting cam and make the activating mechanisms spin in order to lower lid 7 and seat 8 simultaneously, as lid 7 is above seat 8, when lid 7 lowers it pushes seat 8, both lowering simultaneously.

FIG. 8b shows selection button 56 of selecting mechanism 55 (see FIGS. 4 and 5a) positioned to the right where the main cam has been shifted to the right in order for pushing section 33 to activate “A” connecting cam and activate spinning mechanisms to lower only seat 8.

The invention has been sufficiently described for a person with medium level knowledge in the matter to reproduce and obtain the results mentioned on this invention. However, any person capable in the field of the technique for this invention may be capable of making changes not described on this application, however, if for the application of these changes in a determined structure or in the manufacturing process thereof, the matter claimed in these replevin proceedings, said structures shall be included within the scope of the invention.

1. A device with activating mechanisms propelled by hydraulic force to lower the seat and lid of a toilet, of the type containing a carcass accommodating activating mechanisms, with setting means to fix it to the toilet; where one of said means also allows the placing of a hydraulic piston to activate the mechanisms due to the effect of water pressure and pressure differentials when the water tank is unloaded to flush waste; wherein said piston displaces a main cam upward, which is inside the carcass activating the internal action mechanisms consisting of a square arrow adapted to receive and couple, on its inside end, a first “A” connecting cam, and on the outside end, connected to a guiding element located on a supporting base and said base connected to a fluid brake of any type slowing the spinning, which is housed in a support base for the brake that is coupled in an internal cavity of one of the lateral exits with a cavity of the seat and on whose outer face there is a coupling border which is coupled in a cavity similar to the internal face of the two end exits with a cavity on the back of the lid, there is an insert with a central cavity on the cavity of the end exists of the back of the lid; to activate the lid a bolt connecting the lid with the mechanism is found on the cavity of the end exit of the lid, going through the insert, the brake a support base of the square arrow-guiding element, a second “B” connection cam is placed above the main cam, it consists of a first hollow cylinder shaped projection adapted to receive, with spinning capability separate from the end of the square arrow going through the first connecting cam “A”, so the end of said square arrow is the center for spinning the second connecting “B” cam, without interaction between these these, aforesaid second “B” connecting cam includes on the opposite end a central cavity adapted to receive a cylinder body with a cavity receiving the end of a second squared bolt going through a second fluid brake or of any other kind located on the support base for the brake which is coupled in an internal cavity of the other lateral seat exit; on the cavity corresponding to the end exits of the back of the seat there is an insert with a central cavity to activate the seat; said bolt allows the connection of the seat to the mechanism and is found on the cavity of the seat going through the insert, the brake and cylinder shaped body on said second “B” connecting cam; one of said “A” or “B” connecting cams is activated depending on the selection made with a selection mechanism found on the carcass and a selecting button, to lower the seat exclusively or to lower the seat and lid simultaneously.

2. The device with activating mechanisms propelled by hydraulic force to lower the lid and seat of a toilet, pursuant to claim 1, wherein said main cam is located in a compartment of the carcass base, near an end and consists of a vertical stem with two upper arms forming a “T” sliding through two lateral slots of the base compartment, and a perpendicular front arm adapted to receive a spring element that is compressed through a fixed lid with setting means on a zone on top of said compartment to facilitate the return or descent of the cam when there is no ascending force applied on said cam, the main cam also contains a second arm projected backward which defines a pushing section of the first connecting cam “A” or the second connecting cam “B”, coupled on fixed spinning axis and on the toilet seat to make them spin.

3. The device with action mechanisms propelled under hydraulic force to lower the lid and seat of a toilet, pursuant to claim 1, wherein said first “A” connecting cam is shaped like a cylinder with a central cavity and it includes a cylinder shaped projection of smaller diameter where it penetrates and connects to the end of the square arrow and externally includes a semicircular rib as a guide for the circular displacement guide in a slot of the carcass; it includes in addition, a stopping element where the push section of the second arm acts projected behind the principal cam that is activated by the piston.

4. The device with activating mechanisms propelled by hydraulic force to lower the lid and the seat of a toilet, pursuant to claim 1, wherein said second “B” connection cam has a cylinder shape with a central cavity and it includes a cylinder projection with a smaller diameter adapted to receive the end of the square arrow only to support its spin and without interaction between them; and externally includes a semi-circular rib as a guide to the circular displacement rib in a slot of the carcass, including in addition a stoppage element where the push section of the second arm projected behind the main cam activated by the piston.

5. The device with activating mechanisms pushed by hydraulic force to lower the lid and seat of a toilet, pursuant to claim 1, wherein said mechanism to select the “A” or “B” connecting cams is internally mounted on the carcass and defines a selection button mounted in a sliding manner on a back slot of the carcass and which acts over the principal cam, displacing it to act on one of the “A” or “B” connecting cams or to lower simultaneously the lid and seat, or also to leave the main cam in a position to refrain from acting in any of said connecting “A” or “B” connecting cams.

6. The device with activating mechanisms with hydraulic force impulse to lower and seat and lid of a toilet, in accordance with claim 1, wherein said hydraulic piston is retractile and operates with a pressure differential on the inside and consists of a base body including a threaded upper end and a lower end and an intermediate perpendicular derivation with a threaded end; the lower threaded end is adapted to receive, in a threaded manner, a water supply duct from the source of the toilet water supply, the intermediate threaded perpendicular derivation receives in a threaded manner a second water feeding duct to the box or deposit behind the toilet; while the threaded upper end receives a hollow cylinder body with an internal chord and a perimeter seal element, which, receives on the upper end, a threaded upper lid with an adapted perimeter seal to receive the fixing mean of the device to the toilet; internally said piston houses a lower base of the stem with a seal element that receives on its inside face the strength exerted by the water from the water source, and where the arrow of the stem of the piston wrapped by a spring element is coupled, it lies on said lower base for return in the absence of water pressure from the lower end, said upper lid has a threaded central cavity adapted to receive, in a threaded form, the setting means of the device that is hollow and with which said piston is also attached to the toilet and to the device; said piston stem arrow has a cavity on its upper end and is adapted to receive and connect the lower end of said principal cam for the spinning activation of the mechanisms housed within the carcass to make the lid and seat of the toilet spin and lower them.

7. The device with activation mechanisms propelled by hydraulic force to lower the lid and seat of a toilet, pursuant to claim 6, wherein said piston is activated when a lower pressure is produced in the water storage tank of the toilet when the flush lever is activated for the disposal of waste, allowing the water from the water supply duct from the supply source connected on the lower end of the piston offers more pressure, making the water displace the lower end of the stem upward, which has the piston stem arrow inserted and is therefore displaced upward as it is connected to the arrow of the piston stem to the principal cam, it is also displaced upward activating the mechanisms to lower the seat or the lid and the seat simultaneously; the water continues on its way through the intermediate perpendicular derivation where the water feeding duct is connected to the box or deposit until it is filled equaling the internal pressure of the piston allowing water to go through; and the spring element of the stem arrow of the piston aids the return and repositioning of said stem to its starting position; the same is generated in the principal cam which is returned to its starting position under the effect of the spring element.

8. The device with activating mechanisms propelled by hydraulic force to lower the lid and seat of a toilet, pursuant to claim 1, wherein said base has a small orifice allowing the entrance of a volume of water enabling it to displace itself more easily to the starting position.

9. The device with activating mechanisms propelled by hydraulic force to lower the lid and the seat of a toilet, pursuant to claim 1, wherein said hydraulic brake that is coupled on the arrow and bolts for setting on the lid and seat, consists of a cylinder shaped carcass with a seal; said carcass defines a hydraulic chamber with a viscous fluid for control, said cylinder shaped carcass consists of a cylinder shaped cavity adapted to receive and arrow or hollow central pivot housed in said hydraulic control chamber, which includes rabbets and exits on its external wall to receive a moving element for spin control as the elements placing resistance to spinning due to the effect of the viscous fluid inside the hydraulic chamber, on the ends it includes peripheral rabbets to receive seal O-ring to avoid the leaking of a viscous fluid; said arrow or hollow central pivot receives the square bolt fixed to the lid or the seat, therefore said device allows the deceleration of the rotation that buffers the soft falling of the toilet lid and/or seat.
